(19) United States
(12) Patent Application Publication
(10) Pub. No.: US 2025/0065642 A1
(43) Pub. Date: Feb. 27, 2025

(54) CALIBRATION METHOD AND TEST PATTERN

(71) Applicant: SEIKO EPSON CORPORATION, Tokyo (JP)

(72) Inventor: Masahiro MURATA, SHIOJIRI-SHI (JP)

(21) Appl. No.: 18/814,116

(22) Filed: Aug. 23, 2024

(30) Foreign Application Priority Data
Aug. 23, 2023 (JP) 2023-135308

(51) Int. Cl. B41J 2/21; G06K 15/02

(52) U.S. Cl. CPC B41J 2/2135; G06K 15/027; G06K 2215/101

(57) ABSTRACT

A calibration method is used for correcting an inter-apparatus difference among a plurality of printing apparatuses. Each of the plurality of printing apparatuses has a plurality of density settings including a standard density setting serving as a standard of a density. The calibration method includes printing a standard density setting pattern on the printing medium with the standard density setting using one of the printing apparatuses, printing a density setting pattern for each of the plurality of density settings using another one of the plurality of printing apparatuses at a position adjacent to the standard density setting pattern on the printing medium, and setting the density of the density setting pattern closest to the density of the standard density setting pattern among a plurality of the density setting patterns as the standard density setting of the other one of the plurality of printing apparatuses.

The present application is based on, and claims priority from JP Application Serial Number 2023-135308, filed Aug. 23, 2023, the disclosure of which is hereby incorporated by reference herein in its entirety.

### BACKGROUND

### 1. Technical Field

The present disclosure relates to a calibration method, a printing method, and a test pattern.

### 2. Related Art

JP-A-2000-351261 discloses a technique for performing calibration of a printing apparatus based on a result obtained by printing a test pattern by the printing apparatus on a reference sheet on which a reference pattern serving as a color sample is printed.

By causing a plurality of printing apparatuses to print printed matter of the same content, a printing time required for printing a plurality of sets of the printed matter can be reduced. In such a case, it is required to make the color tone uniform among the plurality of printing apparatuses. In the technique described in JP-A-2000-351261, it is necessary to perform the calibration for each of the apparatuses based on the result obtained by printing the test pattern on the reference sheet prepared for each of the plurality of printing apparatuses. There is room for improvement in the calibration method of the related art.

### SUMMARY

A calibration method is used for correcting an inter-apparatus difference among a plurality of printing apparatuses configured to perform printing on a printing medium using a printing agent by attaching the printing agent to the printing medium. The plurality of printing apparatuses each have a plurality of density settings including a standard density setting serving as a standard of a density, with respect to the density of the printing agent attached to the printing medium. The calibration method includes printing a standard density setting pattern on the printing medium with the standard density setting, using one of the plurality of printing apparatuses, printing a density setting pattern for each of the plurality of density settings, using another one of the plurality of printing apparatuses different from the one of the plurality of printing apparatuses, at a position adjacent to the standard density setting pattern on the printing medium, and updating the density of the density setting pattern closest to the density of the standard density setting pattern, among a plurality of the density setting patterns, as the standard density setting of the other one of the plurality of printing apparatuses.

A calibration method is used for correcting an inter-apparatus difference among a plurality of printing apparatuses configured to perform printing on a printing medium using a printing agent by attaching the printing agent to the printing medium. The plurality of printing apparatuses each have a plurality of density settings including a standard density setting serving as a standard of a density, with respect to the density of the printing agent attached to the printing medium. The calibration method includes printing standard density setting patterns on the printing medium with the standard density setting, using at least two of the plurality of printing apparatuses, printing a density setting pattern for each of the plurality of density settings, using another one of the plurality of printing apparatuses different from the printing apparatuses that printed the standard density setting pattern, among the plurality of printing apparatuses, at a position adjacent to the standard density setting pattern for each of the standard density patterns, and updating the density of the density setting pattern closest to the density of the standard density setting pattern, among the plurality of density setting patterns, as the standard density setting of the other one of the plurality of printing apparatuses, in one of combinations obtained by combining one of the standard density setting patterns and a plurality of the density setting patterns adjacent to the one of the standard density setting patterns.

A calibration method is used for correcting an inter-apparatus difference among a plurality of printing apparatuses configured to perform printing on a printing medium using a printing agent by attaching the printing agent to the printing medium. The plurality of printing apparatuses each have a plurality of density settings including a standard density setting serving as a standard of a density, with respect to the density of the printing agent attached to the printing medium. The calibration method includes printing a standard density setting pattern on the printing medium with the standard density setting, using one of the plurality of printing apparatuses, printing a density setting pattern for each of the plurality of density settings, using another one of the plurality of printing apparatuses different from the one of the plurality of printing apparatuses, at a position adjacent to the standard density setting pattern on the printing medium, and performing a density determination of determining a presence or absence of the density setting pattern close to the density of the standard density setting pattern, among a plurality of the density setting patterns. The calibration method further includes, when a result of the density determination indicates the presence, updating the density of the density setting pattern close to the density of the standard density setting pattern, as the standard density setting of the other one of the plurality of printing apparatuses, and, when the result of the density determination indicates the absence, repeating the printing of the standard density setting pattern, using the other one of the plurality of printing apparatuses, the printing of the plurality of density setting patterns, and the density determination until the result of the density determination indicates the presence.

A printing method is a printing method for performing printing on a printing medium using a printing agent by attaching the printing agent to the printing medium. The printing method includes printing a standard density setting pattern printed using a first printing apparatus, among a plurality of printing apparatuses each having a plurality of density settings with respect to a density of the printing agent attached to the printing medium, with a standard density setting, serving as a standard of the density, among the plurality of density settings, and printing a density setting pattern for each of the plurality of density settings using a second printing apparatus different from the first printing apparatus, among the plurality of printing apparatuses, at a position adjacent to the standard density setting pattern.

A test pattern is a test pattern printed on a printing medium using a printing agent by attaching the printing agent to the printing medium. The test pattern includes a standard density setting pattern printed using a first printing apparatus, among a plurality of printing apparatuses each having a plurality of density settings with respect to a density of the printing agent attached to the printing medium, with a standard density setting, serving as a standard of the density, among the plurality of density settings, and a density setting pattern printed for each of the plurality of density settings using a second printing apparatus different from the first printing apparatus, among the plurality of printing apparatuses, at a position adjacent to the standard density setting pattern.

### BRIEF DESCRIPTION OF THE DRAWINGS

FIG. 1 is a diagram illustrating a configuration of a printing system.

FIG. 2 is a block diagram illustrating a configuration of a printing apparatus.

FIG. 3 is a diagram schematically illustrating density setting data.

FIG. 4 is a diagram illustrating a standard density setting pattern.

FIG. 5 is a diagram illustrating a stepwise density pattern.

FIG. 6 is a diagram illustrating an example of a calibration test pattern.

FIG. 7 is a diagram illustrating a flow of a first calibration method.

FIG. 8 is a diagram illustrating an example of the calibration test pattern.

FIG. 9 is a diagram illustrating a flow of a second calibration method.

FIG. 10 is a diagram illustrating an example of the calibration test pattern.

FIG. 11 is a diagram illustrating another configuration of the printing system.

FIG. 12 is a diagram illustrating a flow of a third calibration method.

FIG. 13 is a diagram illustrating a standard density setting pattern.

FIG. 14 is a diagram illustrating an example of the calibration test pattern.

FIG. 15 is a diagram illustrating an example of the calibration test pattern.

FIG. 16 is a diagram illustrating an example of the calibration test pattern.

### DESCRIPTION OF EMBODIMENTS

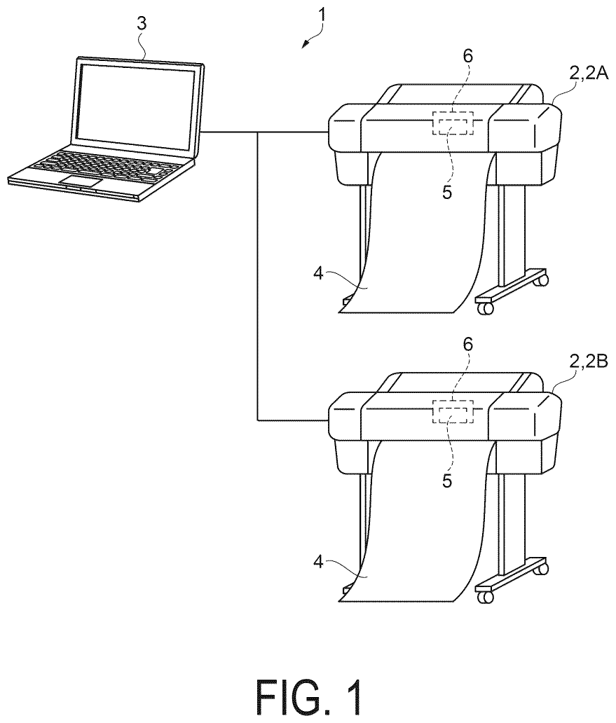

As illustrated in FIG. 1, a printing system 1 includes a plurality of printing apparatuses 2 and a computer 3. The printing apparatus 2 is, for example, an ink jet-type printer configured to discharge ink serving as one example of a liquid onto a medium 4 such as a sheet to print an image of a character, a photo, or the like on the medium 4. The ink is an example of a printing agent. The medium 4 is an example of a printing medium. The printing apparatus 2 includes an ink jet head 5 and a carriage 6. The ink jet head 5 causes the ink to be attached to the medium 4 to perform printing. The carriage 6 causes the ink jet head 5 to reciprocate in a width direction of the medium 4.

The printing apparatus 2 is of a serial type configured to perform printing while causing the ink jet head 5 to reciprocate in the width direction of the medium 4. Further, the printing apparatus 2 includes a transport motor, which will be described below. The transport motor generates power used to transport the medium 4. In the printing apparatus 2, the ink is discharged from the ink jet head 5 toward the medium 4 transported by the power of the transport motor, while causing the carriage 6 to reciprocate in the width direction of the medium 4. In this way, printing is performed on the medium 4 using the ink. The ink jet head 5 may be configured as a line type provided across the width direction of the medium 2. In this embodiment, the printing system 1 includes two of the printing apparatuses 2 as the plurality of printing apparatuses 2. When a distinction is made between the two printing apparatuses 2, they are described as a first printing apparatus 2A and a second printing apparatus 2B. The first printing apparatus 2A is an example of a first printing apparatus, and the second printing apparatus 2B is an example of a second printing apparatus.

The computer 3 supplies print data to the plurality of printing apparatuses 2. The computer 3 is, for example, a personal computer. The plurality of printing apparatuses 2 perform the printing on the medium 4 based on the print data received from the computer 3. The plurality of printing apparatuses 2 cause the ink to be attached to the medium 4 based on the print data, to perform the printing. The computer 3 and the plurality of printing apparatuses 2 are connected to each other so as to be able to communicate with each other. The connection between the computer 3 and the plurality of printing apparatuses 2 may be wired or wireless. The connection between the computer 3 and the plurality of printing apparatuses 2 may be communication via a network such as a local area network (LAN).

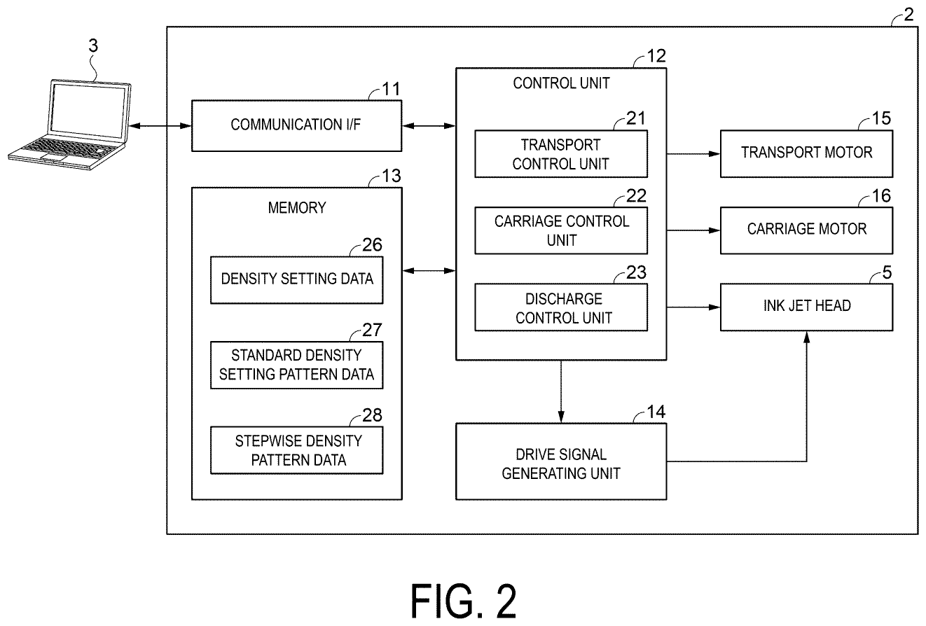

As illustrated in FIG. 2, the printing apparatus 2 includes a communication interface 11, a control unit 12, a memory 13, a driving signal generation circuit 14, a transport motor 15, and a carriage motor 16. In FIG. 2, the interface is abbreviated as I/F. The communication interface 11 is communicatively connected to an external device including the computer 3. The communication interface 11 communicates with the external device in accordance with a predetermined communication protocol. The form of communication may be either wired or wireless. The communication interface 11 includes, for example, a connection port for wired communication, an antenna for wireless communication, and an interface circuit. The communication interface 11 receives the print data from the computer 3. The communication interface 11 transmits various types of data to the computer 3. The communication interface 11 outputs the print data received from the computer 3 to the control unit 12.

The control unit 12 is a controller that controls the printing apparatus 2. The control unit 12 executes a control program stored in the memory 13 to integrally control operations of the printing apparatus 2. The control unit 12 is a processor. As the processor, a central processing unit (CPU) or a micro processing unit (MPU) can be used, for example. The memory 13 includes a random access memory (RAM), a read only memory (ROM), or the like. The RAM is used to temporarily store various types of data or the like, and the ROM stores the control program used to control the operations of the printing apparatus 2, various types of setting data, or the like.

The computing unit 12 executes the control program stored in the memory 13, thereby functioning as various types of functional units. The control unit 12 includes a transport control unit 21, a carriage control unit 22, and a discharge control unit 23 as the functional units. The control unit 12 functions as the transport control unit 21, the carriage control unit 22, and the discharge control unit 23 by executing the control program stored in the memory 13. The transport control unit 21 controls driving of the transport motor 15. The transport motor 15 generates power for transporting the medium 4. The carriage control unit 22 controls driving of the carriage motor 16. The carriage motor 16 generates power for causing the carriage 6 to reciprocate. The discharge control unit 23 controls driving of the ink jet head 5.

The driving signal generation circuit 14 generates a driving signal to be applied to a drive element of the ink jet head 5. A plurality of nozzles (not illustrated) are formed in the ink jet head 5. In the ink jet head 5, the ink can be discharged as ink droplets from each of the nozzle holes by driving the drive element provided for each of the nozzle holes. In the driving signal for driving the drive element of the ink jet head 5, four types of driving pulses are set for each driving period based on the resolution of printing. The ink droplets discharged from the nozzle holes form dots by being attached to the medium 4. The four types of driving pulses correspond to sizes of the dot formed on the medium 4, respectively.

The ink droplets discharged from the nozzle holes are discharged in the sizes corresponding to the four types of driving pulses. By selectively applying the four types of driving pulses to the drive element, the dots of three types of sizes, large, medium, and small, can be formed. Further, the four types of driving pulses also include a driving pulse that does not cause the ink droplets to be discharged. In the drive element of the ink jet head 5, by using the driving signal in which the four types of driving pulses are set, it is possible to control discharge amounts of four gradations for each of the driving periods based on the resolution of printing. In the printing apparatus 2, the gradation of printing on the medium 4 is controlled based on the print data received from the computer 3.

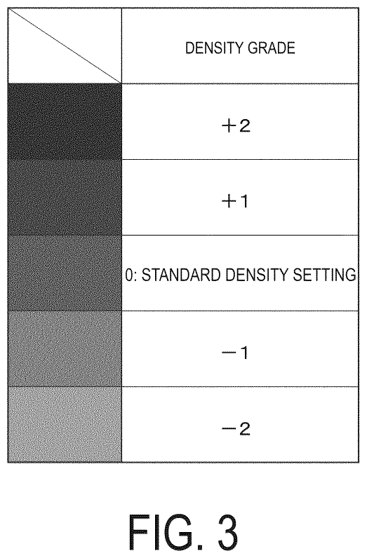

The memory 13 stores density setting data 26, standard density setting pattern data 27, and stepwise density pattern data 28. As illustrated in FIG. 3, the density setting data 26 is data that defines a density that is set in the printing apparatus 2. The density setting data 26 is set for each of the printing apparatuses 2. In the density setting data 26, a density grade is set for each of the printing apparatuses 2. The density setting data 26 is data that defines the density grade. In the example illustrated in FIG. 3, five grades from −2 to +2 are applied as the density grades. The density grade 0 is a standard density. The standard density is a standard density of each of the printing apparatuses 2. In each of the printing apparatuses 2, the density grade 0 is set as a standard density setting.

The density grade can be defined by, for example, the size of the dot formed by the above-described ink droplet. By defining a combination of the dot sizes formed per unit area of the medium 4, it is possible to set a different density for each of the grades. The density grades based on the dot sizes are made uniform among the plurality of printing apparatuses 2. That is, in the same density grade, the combination of the dot sizes per unit area of the medium 4 is the same among the plurality of printing apparatuses 2.

However, an inter-apparatus difference in the discharge amount of ink droplets arises among the plurality of printing apparatuses 2. Due to the manufacturing tolerance, even if the drive element of the ink jet head 5 is driven by the same driving pulse, the inter-apparatus difference in the discharge amount of ink droplets arises among the plurality of printing apparatuses 2 Thus, even if the plurality of printing apparatuses 2 have the same density grade, there may be a difference in density between the printing apparatuses 2. Therefore, at the manufacturing stage of the printing apparatus 2, the density is adjusted for each of the apparatuses based on a density sample. As a result, the inter-apparatus difference in density among the plurality of printing apparatuses 2 is suppressed to be low at the manufacturing stage of the printing apparatus 2. That is, at the manufacturing stage of the printing apparatus 2, variations in the density of the same grade among the plurality of printing apparatuses 2 are suppressed to be low.

The adjustment of the density for each of the printing apparatuses 2 can be realized by, for example, adjusting a voltage value applied to the driving element of the ink jet head 5. In the ink jet head 5, an amount of the ink droplets discharged from the nozzle holes can be changed in accordance with the voltage value of the driving pulse applied to the drive element. When the voltage value of the driving pulse applied to the driving element is changed, a driving amount of the driving element can be changed. As a result, in the ink jet head 5, it is possible to change the discharge amount of ink droplets discharged from the nozzle holes. By adjusting the voltage value of the driving pulse applied to the driving element of the ink jet head 5 for each of the printing apparatuses 2, the density can be adjusted for each of the printing apparatuses 2. As a result, the inter-apparatus difference in density of the same grade is suppressed to be low among the plurality of printing apparatuses 2.

The density setting data 26 illustrated in FIG. 2 includes data that defines the density grades based on the dot sizes, and data that defines the voltage value for adjusting the density for each of the printing apparatuses 2. The print data transmitted from the computer 3 to the printing apparatus 2 includes data indicating an image, a character, or the like to be printed, and data indicating the density of the image, the character, or the like. When the printing apparatus 2 receives the print data from the computer 3, the control unit 12 reads the density setting data 26 from the memory 13. Based on the density setting data 26 read from the memory 13, the control unit 12 causes the ink jet head 5 to print the image or the character having the density indicated by the print data, on the medium 4.

The standard density setting pattern data 27 illustrated in FIG. 2 is data that defines test printing patterns related to the density of ink to be attached to the medium 4. The standard density setting pattern data 27 defines a pattern based on the standard density setting, among the test printing patterns related to the density of ink. The standard density setting is a density setting for the grade 0 illustrated in FIG. 3 described above. That is, the standard density setting pattern data 27 defines the test printing pattern that is printed with the standard density setting. When the print data transmitted from the computer 3 to the printing apparatus 2 instructs test printing based on the standard density setting pattern data 27, the control unit 12 reads the standard density setting pattern data 27 from the memory 13. The control unit 12 causes the ink jet head 5 to perform the printing on the medium 4 based on the standard density setting pattern data 27 read from the memory 13.

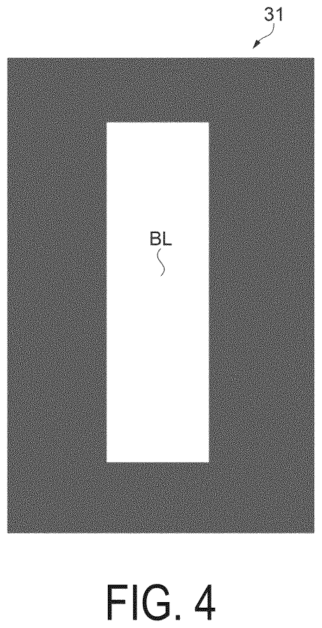

FIG. 4 is a diagram illustrating a standard density setting pattern 31. The control unit 12 causes the standard density setting pattern 31 illustrated in FIG. 4 to be printed on the medium 4 based on the standard density setting pattern data 27. Note that the standard density setting pattern 31 is a pattern to be printed on the medium 4 based on the standard density setting set for each of the printing apparatuses 2. The standard density setting pattern 31 is an annular pattern. In the standard density setting pattern 31, a region in which the ink is attached is formed in an annular shape. The ink is not attached in a region inside the standard density setting pattern 31 formed in the annular shape. That is, a base of the medium 4 is exposed in the region inside the standard density setting pattern 31 formed in the annular shape. The region inside the standard density setting pattern 31 that is formed in the annular shape is referred to as a blank region BL.

The stepwise density pattern data 28 illustrated in FIG. 2 is data that defines test printing patterns related to the density of ink to be attached to the medium 4. The stepwise density pattern data 28 defines patterns of all the grades defined in the density setting data 26 illustrated in FIG. 3, among the test printing patterns related to the density of ink. The stepwise density pattern data 28 defines the test printing patterns to be printed for all the density grades defined by the density setting data 26. When the print data transmitted from the computer 3 to the printing apparatus 2 instructs test printing based on the stepwise density pattern data 28, the control unit 12 reads the stepwise density pattern data 28 from the memory 13. The control unit 12 causes the ink jet head 5 to perform the printing on the medium 4 based on the stepwise density pattern data 28 read from the memory 13.

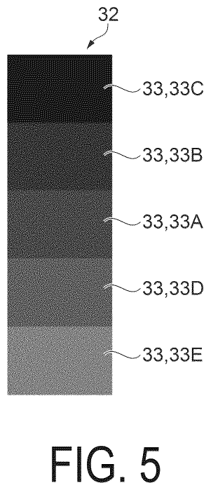

FIG. 5 is a diagram illustrating a stepwise density pattern 32. The control unit 12 causes the stepwise density pattern 32 illustrated in FIG. 5 to be printed on the medium 4 based on the stepwise density pattern data 28. Note that the stepwise density pattern 32 is a pattern printed on the medium 4 based on the density setting data 26 set for each of the printing apparatuses 2. As illustrated in FIG. 5, the stepwise density pattern 32 is a pattern in which density setting patterns 33 for respective density settings are continuously formed in a stepwise manner. Among a plurality of the density setting patterns 33 in the stepwise density pattern 32, the density setting pattern 33 based on the standard density setting illustrated in FIG. 3 is identified as a density setting pattern 33A. The standard density setting illustrated in FIG. 3 is a density setting for the grade 0. Therefore, the density setting pattern 33A illustrated in FIG. 5 is also the density setting pattern 33 based on the density setting for the grade 0.

Among the plurality of density setting patterns 33 in the stepwise density pattern 32 illustrated in FIG. 5, the density setting pattern 33 based on a density setting for the grade +1 is identified as a density setting pattern 33B. Similarly, the density setting pattern 33 based on a density setting for the grade +2 is identified as a density setting pattern 33C. The density setting pattern 33 based on a density setting for the grade −1 is identified as a density setting pattern 33D. The density setting pattern 33 based on a density setting for the grade −2 is identified as a density setting pattern 33E. The stepwise density pattern 32 has a shape and a size that can be accommodated in the blank region BL of the standard density setting pattern 31 illustrated in FIG. 4. The stepwise density pattern 32 is accommodated in the blank region BL of the standard density setting pattern 31 formed in the annular shape.

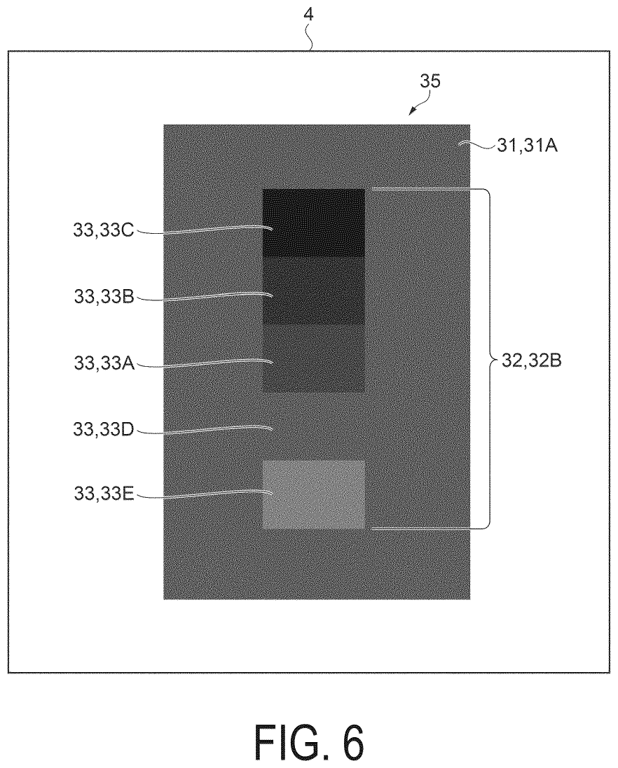

FIG. 6 is a diagram illustrating an example of a calibration test pattern 35. The calibration test pattern 35 is an example of a test pattern. As illustrated in FIG. 6, the calibration test pattern 35 is a test pattern in which the standard density setting pattern 31 and the stepwise density pattern 32 are printed on one medium 4. In the calibration test pattern 35, the standard density setting pattern 31 is printed using one of the printing apparatuses 2 of the first printing apparatus 2A and the second printing apparatus 2B illustrated in FIG. 1. In the calibration test pattern 35, the stepwise density pattern 32 is printed using another one of the printing apparatuses 2 of the first printing apparatus 2A and the second printing apparatus 2B. That is, in the calibration test pattern 35, the standard density setting pattern 31 and the stepwise density pattern 32 are printed using the different printing apparatuses 2, respectively.

For example, a case where the standard density setting pattern 31 illustrated in FIG. 6 is printed using the first printing apparatus 2A will be described. In this case, the stepwise density pattern 32 is printed using the second printing apparatus 2B. The standard density setting pattern 31 printed using the first printing apparatus 2A is identified as a standard density setting pattern 31A. The stepwise density pattern 32 printed using the second printing apparatus 2B is identified as a stepwise density pattern 32B. As described above, the stepwise density pattern 32B is printed inside the standard density setting pattern 31A. That is, the stepwise density pattern 32B is located in the blank area BL of the standard density setting pattern 31A illustrated in FIG. 4.

As illustrated in FIG. 6, the stepwise density pattern 32B is surrounded by the standard density setting pattern 31A. Thus, the standard density setting pattern 31A and the stepwise density pattern 32B are adjacent to each other. Note that if the standard density setting pattern 31 and each of the plurality of density setting patterns 33 of the stepwise density pattern 32 are adjacent to each other, the stepwise density pattern 32 need not necessarily be surrounded by the standard density setting pattern 31.

A method for printing the calibration test pattern 35 includes printing the standard density setting pattern 31A on the medium 4 with the standard density setting using the first printing apparatus 31A, which is the one of the printing apparatuses 2 among the plurality of printing apparatuses 2. The method for printing the calibration test pattern 35 includes printing the density setting pattern 33 for each of the plurality of density settings using the second printing apparatus 2B, at a position adjacent to the standard density setting pattern 31A on the medium 4. The second printing apparatus 2B is the other one of the printing apparatuses 2 different from the first printing apparatus 2A, which is the one of the printing apparatuses 2 among the plurality of printing apparatuses 2. By this printing method, the calibration test pattern 35 can be printed. Note that, in the method for printing the calibration test pattern 35, either the printing of the standard density setting pattern 31 or the printing of the stepwise density pattern 32 may be performed in advance of the other.

In the example illustrated in FIG. 6, the density setting pattern 33 closest to the density of the standard density setting pattern 31A among the plurality of density setting patterns 33 of the stepwise density pattern 32B is the density setting pattern 33D. The density setting pattern 33D is not the standard density setting. The density setting pattern 33D is the density setting for the grade −1. That is, the density setting for the grade −1 of the second printing apparatus 2B is equivalent to the standard density setting of the first printing apparatus 2A. Thus, if the density of the grade −1 of the second printing apparatus 2B is updated as the standard density setting of the second printing apparatus 2B, it is possible to make the density uniform between the first printing apparatus 2A and the second printing apparatus 2B. Note that the standard density setting of the printing apparatus 2 is updated by updating the density setting data 26 illustrated in FIG. 2. That is, when the standard density setting of the printing apparatus 2 is updated, the density setting data 26 illustrated in FIG. 2 is overwritten with the updated density setting.

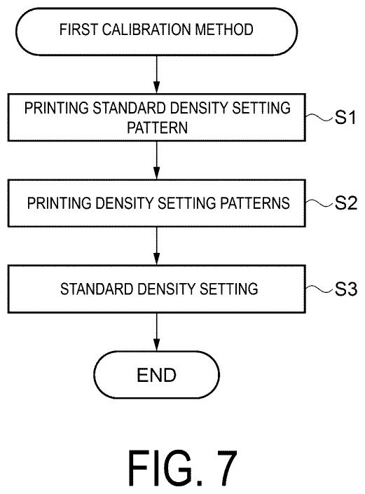

FIG. 7 is a diagram illustrating a flow of a first calibration method. As illustrated in FIG. 7, the first calibration method includes step S1, step S2, and step S3. Step S1 is a step of printing the standard density setting pattern 31 on the medium 4 with the standard density setting using one of the printing apparatuses 2 among the plurality of printing apparatuses 2. That is, step S1 is a step of printing the standard density setting pattern 31A on the medium 4 with the standard density setting using the first printing apparatus 2A.

Step S2 is a step of printing the density setting pattern 33 for each of the plurality of density settings at a position adjacent to the standard density setting pattern 31 on the medium 4 using another one of the printing apparatuses 2 different from the one of the printing apparatuses 2 among the plurality of printing apparatuses 2. That is, step S2 is a step of printing the plurality of density setting patterns 33 using the second printing apparatus 2B at positions adjacent to the standard density setting pattern 31A on the medium 4. Step S3 is a step of updating the density of the density setting pattern 33 closest to the density of the standard density setting pattern 31 among the plurality of density setting patterns 33, as the standard density setting of the second printing apparatus 2B, which is the other one of the printing apparatuses 2. Note that either step S1 or step S2 may be performed in advance of the other.

According to the first calibration method, the density of the density setting pattern 33 closest to the density of the standard density setting pattern 31 printed using the one of the printing apparatuses 2 can be updated as the standard density setting of the other one of the printing apparatuses 2. Accordingly, the density setting of the one of the printing apparatuses 2 and the density setting of the other one of the printing apparatuses 2 can be easily matched with each other. As a result, it is easy to make the density uniform among the plurality of printing apparatuses 2. Further, according to the first calibration method, the standard density setting pattern 31 and each of the plurality of density setting patterns 33 of the stepwise density pattern 32 are adjacent to each other. Thus, it is easy to compare the standard density setting pattern 31 with the plurality of density setting patterns 33. As a result, it is easy to recognize the density setting pattern 33 closest to the density of the standard density setting pattern 31 among the plurality of density setting patterns 33 of the stepwise density pattern 32. The comparison between the standard density setting pattern 31 and the plurality of density setting patterns 33 may be performed by visual observation with human eyes or by using a device such as a colorimeter.

Note that it is preferable to prevent the standard density setting pattern 31 and the plurality of density setting patterns 33 from overlapping with each other. This is desirable from the viewpoint of comparing the standard density setting pattern 31 with the plurality of density setting patterns 33. This is because, if there is a region where the standard density setting pattern 31 and the plurality of density setting patterns 33 overlap with each other, it is difficult to accurately ascertain the density. On the other hand, it is also preferable to prevent a gap from being created between the standard density setting pattern 31 and the plurality of density setting patterns 33 that are adjacent to each other. This is also desirable from the viewpoint of comparing the standard density setting pattern 31 with the plurality of density setting patterns 33. When the base of the medium 4 is exposed from the gap between the standard density setting pattern 31 and the plurality of density setting patterns 33 that are adjacent to each other, it becomes difficult to make a determination by visual observation. This is because the standard density setting pattern 31 and the plurality of density setting patterns 33 become separated from each other.

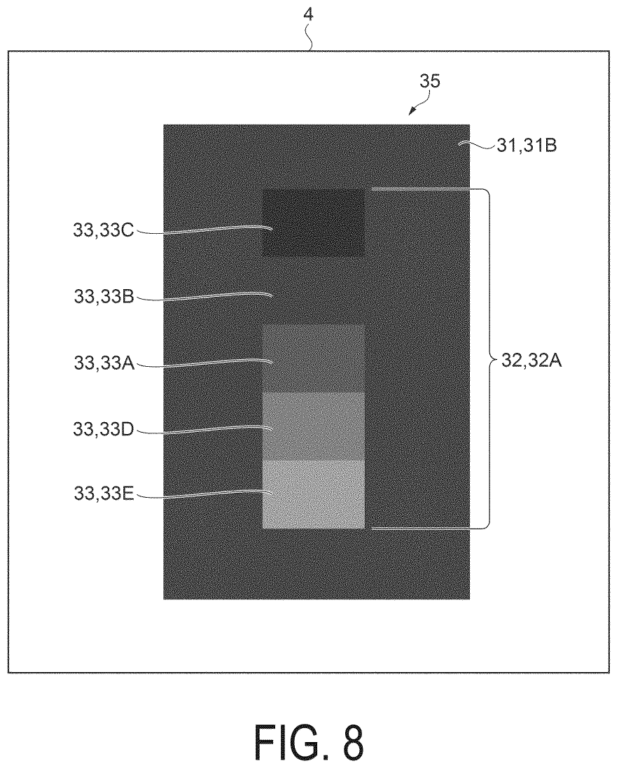

A case where the standard density setting pattern 31 is printed using the second printing apparatus 2B will be described. FIG. 8 is a diagram illustrating an example of the calibration test pattern 35. In the example illustrated in FIG. 8, the standard density setting pattern 31 is printed using the second printing apparatus 2B, and the stepwise density pattern 32 is printed using the first printing apparatus 2A. The standard density setting pattern 31 printed using the second printing apparatus 2B is identified as a standard density setting pattern 31B. Further, the stepwise density pattern 32 printed using the first printing apparatus 2A is identified as a stepwise density pattern 32A.

In the example illustrated in FIG. 8, the density setting pattern 33 closest to the density of the standard density setting pattern 32A among the plurality of density setting patterns 33 of the stepwise density pattern 31B is the density setting pattern 33B. The density setting pattern 33B is not the standard density setting. The density setting pattern 33B is the density setting for the grade +1. In other words, the density setting for the grade +1 of the first printing apparatus 2A is equivalent to the standard density setting of the second printing apparatus 2B. Therefore, if the density of the grade +1 of the first printing apparatus 2A is updated as the standard density setting of the first printing apparatus 2A, it is possible to make the density uniform between the first printing apparatus 2A and the second printing apparatus 2B.

As illustrated in the example of FIG. 6 and the example of FIG. 8, depending on whether the standard density setting pattern 31 is printed using the first printing apparatus 2A or the second printing apparatus 2B, the density of the standard density setting used as a uniform density among the plurality of printing apparatuses 2 may be different. In such a case, the density of the density setting pattern 33D illustrated in FIG. 6 and the density of the density setting pattern 33B illustrated in FIG. 8 can be candidates for a density to be used as the uniform density. The candidate for the density to be used as the uniform density is referred to as a candidate density. When a plurality of the candidate densities are present, it is preferable to adopt the highest density among the plurality of candidate densities. In the above-described example, the candidate density is higher when the standard density setting pattern 31 is printed using the second printing apparatus 2B than when the standard density setting pattern 31 is printed using the first printing apparatus 2A. Thus, the density of the density setting pattern 33B, which is the candidate density when the standard density setting pattern 31 is printed using the second printing apparatus 2B, is adopted.

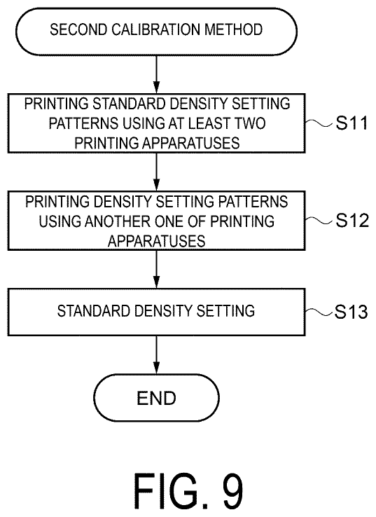

As illustrated in FIG. 9, a second calibration method includes step S11, step S12, and step S13. Step S11 is a step of printing the standard density setting patterns 31 on the medium 4 with the standard density setting using at least two of the printing apparatuses 2 of the plurality of printing apparatuses 2. The standard density setting patterns 31 printed using the at least two printing apparatuses 2 may be printed on the media 4 different from each other, or may be printed on the same medium 4. Step S12 is a step of printing the density setting pattern 33 for each of the plurality of density settings at a position adjacent to the standard density setting pattern 31 for each of the standard density setting patterns 31, using another one of the printing apparatuses 2. The other one of the printing apparatuses 2 is the printing apparatus 2 different from the printing apparatuses 2 that have printed the standard density setting patterns 31 among the plurality of printing apparatuses 2.

Either step S11 or step S12 may be performed in advance of the other. By step S11 and step S12, a plurality of combinations, each of which is obtained by combining one of the standard density setting patterns 31 and the plurality of density setting patterns 33 that are adjacent to each other, are printed. Step S13 is a step of updating the density of the density setting pattern 33 closest to the density of the standard density setting pattern 31 in one of the plurality of combinations as the standard density setting of the other one of the printing apparatuses 2.

According to the second calibration method, the density of the density setting pattern 33 closest to the density of the adjacent standard density setting pattern 31 among the plurality of density setting patterns 33 can be updated as the standard density setting of the other one of the printing apparatuses 2. Accordingly, the density setting of the one of the printing apparatuses 2 and the density setting of the other one of the printing apparatuses 2 can be easily matched with each other. As a result, it is easy to make the density uniform among the plurality of printing apparatuses 2. Further, according to this calibration method, the plurality of combinations, each of which is obtained by combining the one standard density setting pattern 31 and the plurality of density setting patterns 33 that are adjacent to each other, can be printed. As a result, since each of the plurality of combinations can present an option, it is possible to increase the number of options for the density setting.

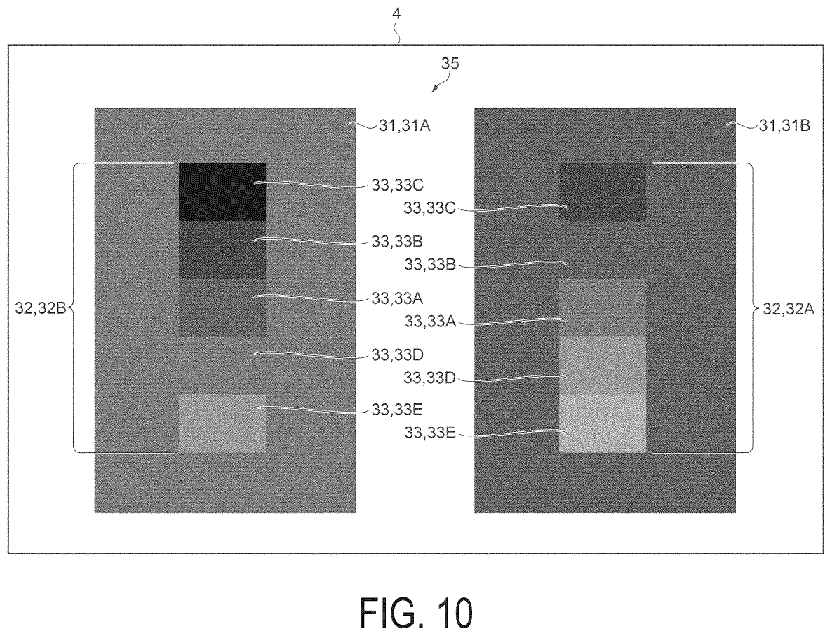

In the second calibration method, it is preferable that the candidate density is selected in each of the plurality of combinations, and the highest density among the plurality of candidate densities is updated as the standard density setting of the other one of the printing apparatuses 2. According to this calibration method, the standard density settings of the plurality of printing apparatuses 2 can be made uniform at the highest density. Note that, in a method for extracting the highest density among the plurality of candidate densities, it is preferable to print the plurality of combinations on the same medium 4 as illustrated in FIG. 10. This is because it is easy to view the entirety of the plurality of combinations in this manner.

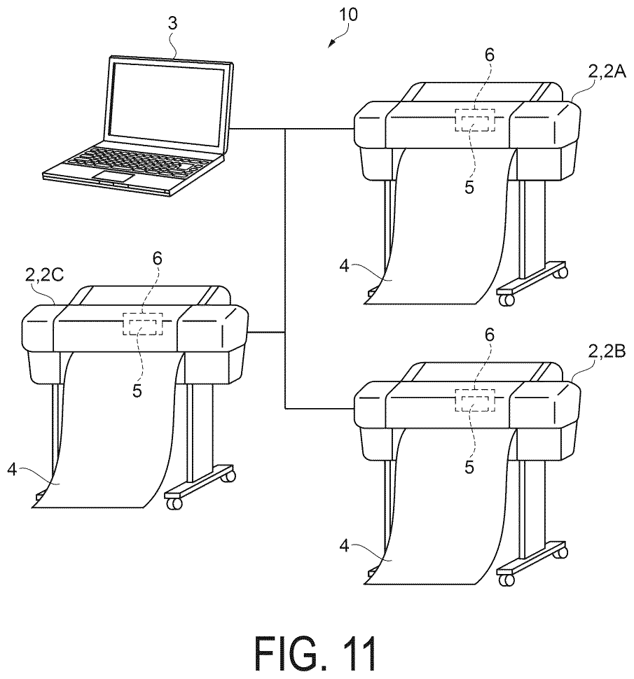

The number of printing apparatuses 2 included in the printing system 1 is not limited to two. The number of printing apparatuses 2 included in the printing system 1 may exceed two. As illustrated in FIG. 11, a printing system 10 including three of the printing apparatuses 2 will be described. The printing system 10 has the same configuration as that of the printing system 1 except that a third printing apparatus 2C is provided. Thus, of the configurations of the printing system 10, the same configurations as those of the printing system 1 are denoted by the same reference signs as those of the printing system 1, and detailed description thereof will be omitted. The third printing apparatus 2C has a configuration similar to that of the first printing apparatus 2A and the second printing apparatus 2B. Thus, of the configurations of the third printing apparatus 2C, the same configurations as those of the first printing apparatus 2A and the second printing apparatus 2B are denoted by the same reference signs as those of the first printing apparatus 2A and the second printing apparatus 2B, and detailed description thereof will be omitted. The third printing apparatus 2C is connected to the computer 3. The third printing apparatus 2C and the computer 3 can communicate with each other.

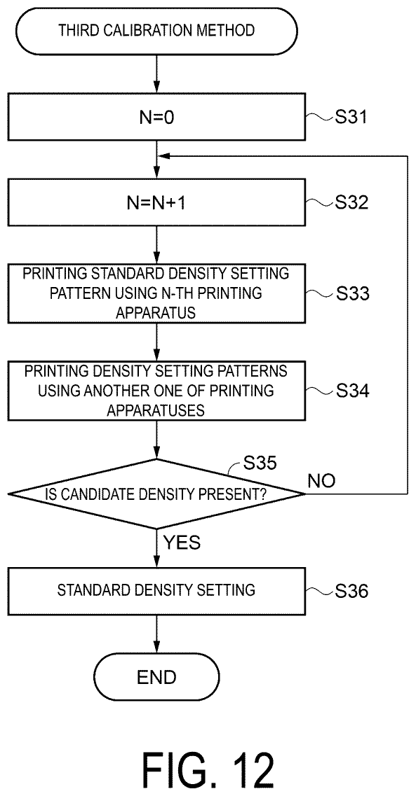

As illustrated in FIG. 12, a third calibration method includes six steps from step S31 to step S36. Step S31 is a step of initializing a variable N by assigning 0 to the variable N. The variable N is a variable for counting the ordinal numbers of the plurality of printing apparatuses 2. Step S32 is a step of incrementing the variable N by adding 1 to the variable N. Step S33 is a step of printing the standard density setting pattern 31 on the medium 4 with the standard density setting using the N-th printing apparatus 2. Step S33 corresponds to printing the standard density setting pattern 31 on the medium 4 with the standard density setting using one of the printing apparatuses 2.

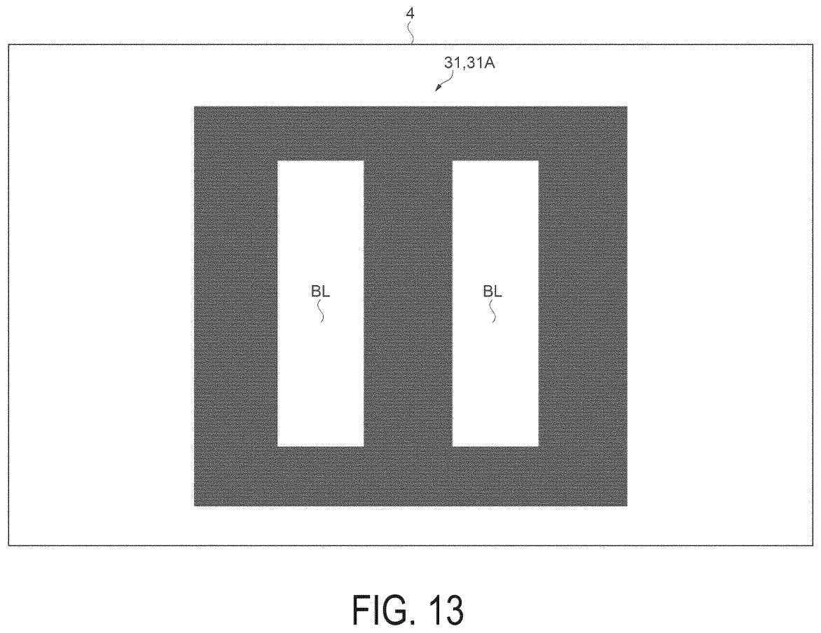

For example, when N=1, step S33 corresponds to printing the standard density setting pattern 31A on the medium 4 with the standard density setting using the first printing apparatus 2A. In the third calibration method, as illustrated in FIG. 13, the standard density setting pattern 31A is printed on the medium 4 with the standard density setting using the first printing apparatus 2A. In the printing system 10 including the three printing apparatuses 2, two of the blank regions BL are formed in the standard density setting pattern 31. A number K of the blank regions BL formed in the standard density setting pattern 31 is generalized by the following equation (1).

$$K = M - 1 \qquad ( 1 )$$

M is the number of printing apparatuses 2 included in the printing system 10, and is a natural number equal to or greater than 2.

Returning to FIG. 12, step S34 is a step of printing the density setting pattern 33 for each of the plurality of density settings using another one of the printing apparatuses 2. Step S34 corresponds to printing the density setting pattern 33 for each of the density settings at a position adjacent to the standard density setting pattern 31 on the medium 4 using another one of the printing apparatuses 2 different from one of the printing apparatuses 2 among the plurality of printing apparatuses 2.

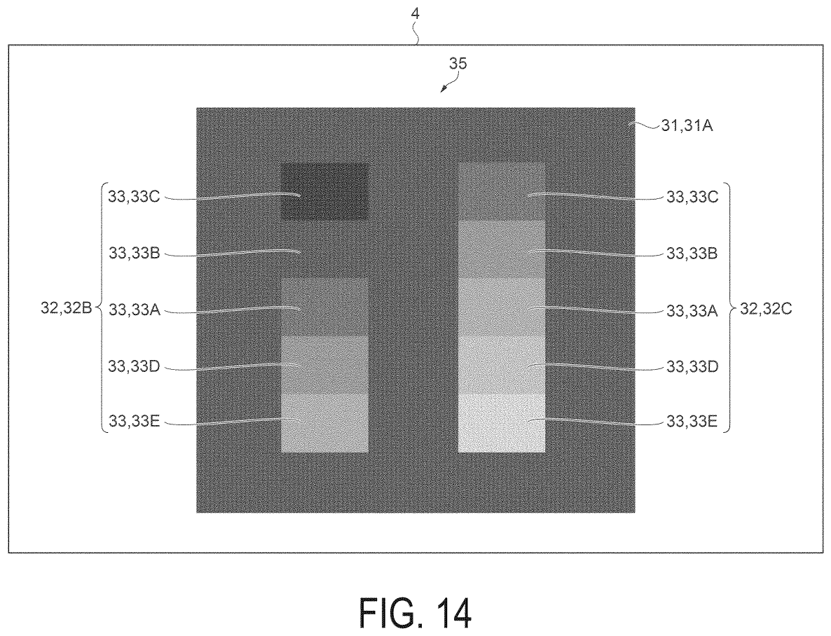

When N=1, step S34 corresponds to printing the density setting pattern 33 for each of the density settings using each of the second printing apparatus 2B and the third printing apparatus 2C. By step S34, as illustrated in FIG. 14, the stepwise density pattern 32B and a stepwise density pattern 32C are printed at positions adjacent to the standard density setting pattern 31A. The stepwise density pattern 32B is the stepwise density pattern 32 printed using the second printing apparatus 2B. The stepwise density pattern 32C is the stepwise density pattern 32 printed using the third printing apparatus 2C.

Returning to FIG. 12, step S35 is a step of determining whether or not the candidate density is present. Step S35 corresponds to a density determination of determining a presence or absence of the density setting pattern 33 close to the density of the standard density setting pattern 31, among the plurality of density setting patterns 33. When the determination result at step S35 indicates the presence, that is, when the determination result is YES, the processing proceeds to step S36. When the determination result at step S35 indicates the absence, that is, when the determination result is NO, the processing proceeds to step S32.

Here, it is determined whether or not the candidate density is present in the calibration test pattern 35 illustrated in FIG. 14. The density of the density setting pattern 33B in the stepwise density pattern 32B printed using the second printing apparatus 2B is equivalent to the density of the standard density setting pattern 31A printed using the first printing apparatus 2A. On the other hand, in the stepwise density pattern 32C printed using the third printing apparatus 2C, there is no density setting pattern 33 close to the density of the standard density setting pattern 31A printed using the first printing apparatus 2A. Thus, as the determination result, it is determined that the candidate density is not present in the calibration test pattern 35 illustrated in FIG. 14. Therefore, in this case, the processing proceeds to step S32 illustrated in FIG. 12.

When the result of the density determination at step S35 indicates the absence, step S32, step S33, step S34, and step S35 are repeated until the result of the density determination at step S35 indicates the presence. That is, the third calibration method includes, when the result of the density determination indicates the absence, repeating the printing of the standard density setting pattern 31 using another one of the printing apparatuses 2, the printing of the plurality of density setting patterns 33, and the density determination until the result of the density determination indicates the presence. As illustrated in FIG. 14, the candidate density is not present in the standard density setting pattern 31A printed using the first printing apparatus 2A. Therefore, subsequently, the candidate density is searched for in the standard density setting pattern 31B printed using the second printing apparatus 2B.

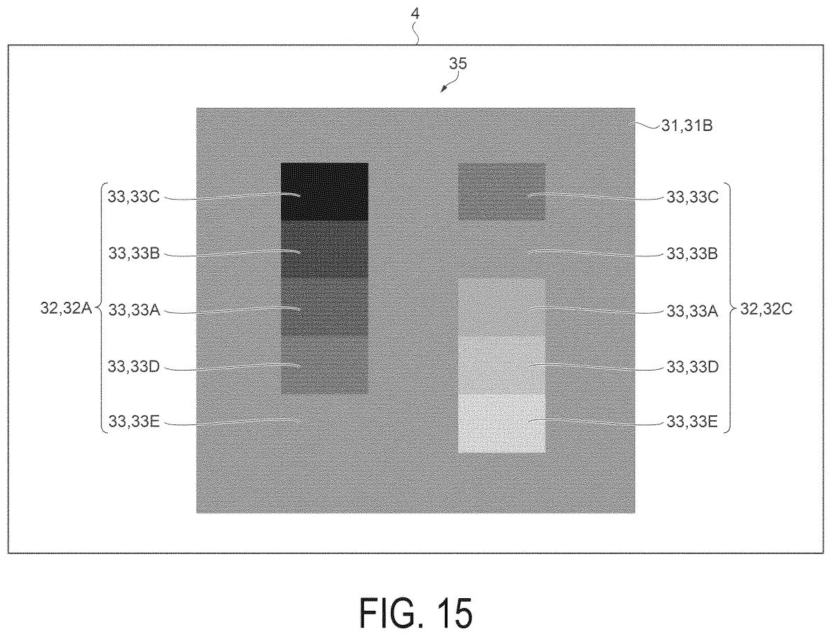

FIG. 15 is a diagram illustrating an example of the calibration test pattern 35. The example illustrated in FIG. 15 is the calibration test pattern 35 including the standard density setting pattern 31B printed using the second printing apparatus 2B. In the example illustrated in FIG. 15, the density of the density setting pattern 33E of the stepwise density pattern 32A printed using the first printing apparatus 2A is equivalent to the density of the standard density setting pattern 31B printed using the second printing apparatus 2B. The density of the density setting pattern 33B of the stepwise density pattern 32C printed using the third printing apparatus 2C is equivalent to the density of the standard density setting pattern 31B printed using the second printing apparatus 2B. Thus, as the determination result, it is determined that the candidate density is present in the calibration test pattern 35 illustrated in FIG. 15. Therefore, in this case, the processing proceeds to step S36 illustrated in FIG. 12.

Step S36 is a step of performing standard density setting. Step S36 corresponds to updating the density of the density setting pattern 33 close to the density of the standard density setting pattern 31 as the standard density setting of another one of the printing apparatuses 2. In the example of the calibration test pattern 35 illustrated in FIG. 15, the first printing apparatus 2A and the third printing apparatus 2C each correspond to the other one of the printing apparatuses 2. At step S36, the density of the density setting pattern 33E in the first printing apparatus 2A is set as the standard density setting of the first printing apparatus 2A. Further, at step S36, the density of the density setting pattern 33B in the third printing apparatus 2C is set as the standard density setting of the third printing apparatus 2C. That is, the density for the grade −2 in the first printing apparatus 2A is set as the standard density setting of the first printing apparatus 2A. Further, the density for the grade +1 in the third printing apparatus 2C is set as the standard density setting of the third printing apparatus 2C.

According to the third calibration method, the density of the density setting pattern 33 closest to the density of the standard density setting pattern 31 printed using one of the printing apparatuses 2 can be updated as the standard density setting of another one of the printing apparatuses 2. Accordingly, the density setting of the one of the printing apparatuses 2 and the density setting of the other one of the printing apparatuses 2 can be easily matched with each other. As a result, it is easy to make the density uniform among the plurality of printing apparatuses 2. Further, the third calibration method includes, when the result of the density determination indicates the absence, performing the printing of the standard density setting pattern 31 using another one of the printing apparatuses 2, and the printing of the plurality of density setting patterns 33. Accordingly, it becomes easier to reduce necessary printing compared to a case where the combinations, each of which is obtained by combining the standard density setting pattern 31 and the plurality of density setting patterns 33, are printed using each of the printing apparatuses 2 from the start.

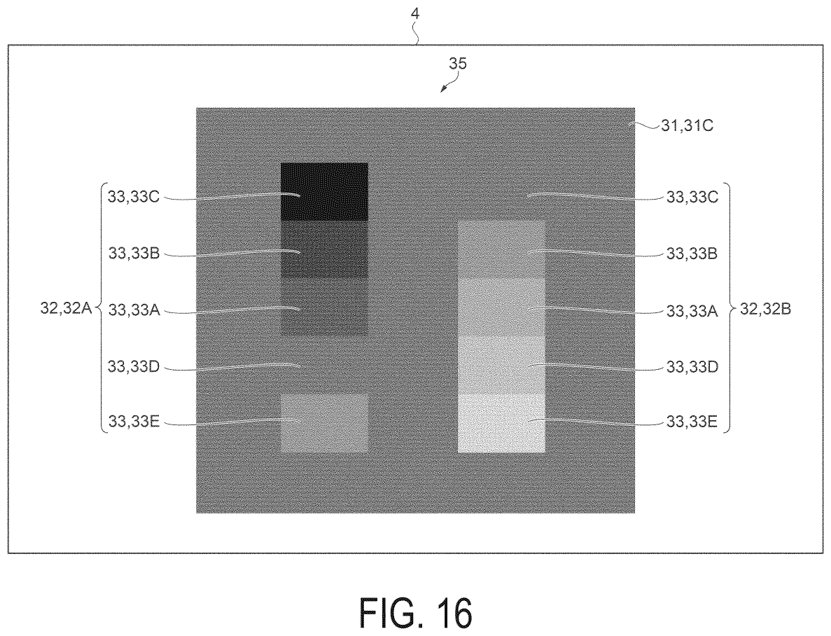

Note that, also in the third calibration method, when a plurality of the candidate densities having different density grades are present, it is preferable to adopt the highest density among the plurality of candidate densities. FIG. 16 is a diagram illustrating an example of the calibration test pattern 35. The example illustrated in FIG. 16 is the calibration test pattern 35 including the standard density setting pattern 31C printed using the third printing apparatus 2C. In the example illustrated in FIG. 16, the density of the density setting pattern 33D of the stepwise density pattern 32A printed using the first printing apparatus 2A is equivalent to the density of the standard density setting pattern 31C printed using the third printing apparatus 2C. The density of the density setting pattern 33C of the stepwise density pattern 32B printed using the second printing apparatus 2B is equivalent to the density of the standard density setting pattern 31C printed using the third printing apparatus 2C. The candidate density in the example illustrated in FIG. 16 is higher than the candidate density in the example illustrated in FIG. 15. Therefore, in this case, the candidate density in the example illustrated in FIG. 16 is adopted. That is, in this case, the density for the grade −1 in the first printing apparatus 2A is set as the standard density setting of the first printing apparatus 2A. Further, the density for the grade +2 in the second printing apparatus 2B is set as the standard density setting of the second printing apparatus 2B.

When each of the plurality of printing apparatuses 2 is capable of performing the printing on the medium 4 with inks of a plurality of colors, a method of performing calibration based on the calibration test pattern 35 printed with ink of one color among the plurality of colors may be employed. In this case, each of the plurality of printing apparatuses 2 is capable of performing the printing on the medium 4 with the inks of the plurality of colors, and has a plurality of density settings for each of the colors of the ink. This calibration method is referred to as a fourth calibration method. The fourth calibration method can be applied to any of the first calibration method, the second calibration method, and the third calibration method. According to this calibration method, the standard density setting set for one color of the plurality of colors can be applied to the standard density setting for the other colors. Accordingly, it is possible to avoid printing the calibration test pattern 35 for all of the colors.

It is also possible to employ a method of performing calibration for each type of the medium 4. This calibration method is referred to as a fifth calibration method. Depending on the type of the medium 4, the density of the ink, or the appearance such as the color tone of the ink may vary. Further, the degree of bleed-through of the ink may vary depending on the type of the medium 4. Therefore, the fifth calibration method, in which the calibration is performed for each type of the medium 4, is preferable. According to the fifth calibration method, it is easy to reduce a difference in density caused by the type of the medium 4. In the fifth calibration method, it is effective to store the type of the medium 4 on which the calibration has been performed, as a record. For example, it is possible to determine whether or not the type of the medium 4 is a new type, by storing histories of the type of medium 4 on which the calibration has been performed in the memory 13 of the printing apparatus 2 or in a memory of the computer 3. Accordingly, it is possible to quickly recognize whether or not the medium 4 is the medium 4 on which the calibration is to be performed.

According to the calibration method of this embodiment, in the printing system 1 or the printing system 10 including the plurality of printing apparatuses 2, it is possible to make the density of printing uniform among the plurality of printing apparatuses 2. This is preferable, for example, when the same printed matter is produced using a plurality of the printing apparatuses 2. If there is an inter-apparatus difference in density among the plurality of printing apparatuses 2, variations in the density and the color tone become noticeable in the same printed matter. It is conceivable that the inter-apparatus difference among the plurality of printing apparatuses 2 arises due to, for example, aging. According to the calibration method of this embodiment, when the same printed matter is produced by the plurality of printing apparatuses 2, it is possible to suppress the variations in the density and the color tone in a plurality of sets of the printed matter. Note that, in this embodiment, the ink jet printer is used as the printing apparatus 2. However, the printing apparatus 2 is not limited to the ink jet printer. For example, a laser printer can also be used as the printing apparatus 2.

What is claimed is:

1. A calibration method for correcting an inter-apparatus difference among a plurality of printing apparatuses configured to perform printing on a printing medium using a printing agent by attaching the printing agent to the printing medium, the plurality of printing apparatuses each having a plurality of density settings including a standard density setting serving as a standard of a density, with respect to the density of the printing agent attached to the printing medium, and the calibration method comprising:
printing a standard density setting pattern on the printing medium with the standard density setting, using one of the plurality of printing apparatuses;
printing a density setting pattern for each of the plurality of density settings, using another one of the plurality of printing apparatuses different from the one of the plurality of printing apparatuses, at a position adjacent to the standard density setting pattern on the printing medium; and
updating the density of the density setting pattern closest to the density of the standard density setting pattern, among a plurality of the density setting patterns, as the standard density setting of the other one of the plurality of printing apparatuses.

2. A calibration method for correcting an inter-apparatus difference among a plurality of printing apparatuses configured to perform printing on a printing medium using a printing agent by attaching the printing agent to the printing medium, the plurality of printing apparatuses each having a plurality of density settings including a standard density setting serving as a standard of a density, with respect to the density of the printing agent attached to the printing medium, and the calibration method comprising:
printing standard density setting patterns on the printing medium with the standard density setting, using at least two of the plurality of printing apparatuses;
printing a density setting pattern for each of the plurality of density settings, using another one of the plurality of printing apparatuses different from the printing apparatuses that printed the standard density setting pattern, among the plurality of printing apparatuses, at a position adjacent to the standard density setting pattern for each of the standard density patterns; and
updating the density of the density setting pattern closest to the density of the standard density setting pattern, among the plurality of density setting patterns, as the standard density setting of the other one of the plurality of printing apparatuses, in one of combinations obtained by combining one of the standard density setting patterns and a plurality of the density setting patterns adjacent to the one of the standard density setting patterns.

3. The calibration method according to claim 2, wherein
in each of a plurality of the combinations, the density of the density setting pattern closest to the density of the standard density setting pattern, among the plurality of density setting patterns, is regarded as a candidate density, and
the highest density, among a plurality of the candidate densities, is updated as the standard density setting of the other one of the plurality of printing apparatus.

4. The calibration method according to claim 1, wherein
each of the plurality of printing apparatuses is configured to perform the printing on the printing medium using the printing agent of a plurality of colors, and has the plurality of density settings including the standard density setting for each of the plurality of colors of the printing agent, and
the standard density setting, of the other one of the plurality of printing apparatuses, set based on a result obtained by printing the standard density setting pattern and the plurality of density setting patterns using the printing agent of one of the plurality of colors, is updated as the standard density setting of another one of the plurality of colors.

5. A calibration method for correcting an inter-apparatus difference among a plurality of printing apparatuses configured to perform printing on a printing medium using a printing agent by attaching the printing agent to the printing medium, the plurality of printing apparatuses each having a plurality of density settings including a standard density setting serving as a standard of a density, with respect to the density of the printing agent attached to the printing medium, and the calibration method comprising:
printing a standard density setting pattern on the printing medium with the standard density setting, using one of the plurality of printing apparatuses;
printing a density setting pattern for each of the plurality of density settings, using another one of the plurality of printing apparatuses different from the one of the plurality of printing apparatuses, at a position adjacent to the standard density setting pattern on the printing medium;
performing a density determination of determining a presence or absence of the density setting pattern close to the density of the standard density setting pattern, among a plurality of the density setting patterns;
when a result of the density determination indicates the presence, updating the density of the density setting pattern close to the density of the standard density setting pattern, as the standard density setting of the other one of the plurality of printing apparatuses; and
when the result of the density determination indicates the absence, repeating the printing of the standard density setting pattern using the other one of the plurality of printing apparatuses, the printing of the plurality of density setting patterns, and the density determination until the result of the density determination indicates the presence.

6. The calibration method according to claim 1, wherein
calibration is performed for each of types of the printing medium.

7. A test pattern printed on a printing medium using a printing agent by attaching the printing agent to the printing medium, the test pattern comprising:
a standard density setting pattern printed using a first printing apparatus, among a plurality of printing apparatuses each having a plurality of density settings with respect to a density of the printing agent attached to the printing medium, with a standard density setting, serving as a standard of the density, among the plurality of density settings; and
a density setting pattern printed for each of the plurality of density settings using a second printing apparatus different from the first printing apparatus, among the plurality of printing apparatuses, at a position adjacent to the standard density setting pattern.
